(19) United States
(12) Patent Application Publication
(10) Pub. No.: US 2026/0257150 A1
(43) Pub. Date: Sep. 3, 2026

(54) Method and device for extracting substances from the adsorbent layer of a chromatographic plate

(71) Applicant: SFPE SP. Z.O.O., Lublin (PL)

(72) Inventors: Tadeusz Henryk Dzido, Lublin (PL); Szarek Mikolaj, Bielsko-Biala (PL); Sordyl Marek, Roczyny (PL)

(21) Appl. No.: 19/521,842

(22) PCT Filed: Sep. 19, 2024
(86) PCT No.: PCT/PL2024/000051

§ 371 Date: Mar. 20, 2026

(30) Foreign Application Priority Data
Sep. 20, 2023 (PL) P.446190

(51) Int. Cl. B01D 15/20; B01D 15/42; G01N 1/10; G01N 1/40; G01N 30/90

(52) U.S. Cl. CPC B01D 15/20; B01D 15/424; G01N 1/10; G01N 1/4077; G01N 30/90; G01N 2001/4088

(57) ABSTRACT

The subject of the invention is a method and device for extracting substances from the adsorbent layer of a chromatographic plate. According to the invention, the method consists in creating a microvessel, the wall of which is the wall of a sleeve pressed perpendicularly through the adsorbent layer to the carrier plate of the chromatographic plate, and the bottom is the carrier plate of the chromatographic plate. A portion or portions of the extracting liquid from several dozen to several hundred microliters are added to the microvessel thus created. An extract is obtained, which after being withdrawn from the sleeve is subjected to qualitative and/or quantitative analysis using instrumental techniques. The method is carried out using a device that is a type of mechanism pressing the sleeve perpendicularly to the chromatographic plate. The sleeve has a specially profiled lower edge, which facilitates obtaining a tight connection of the lower part of the sleeve with the carrier plate of the chromatographic plate. The device uses replaceable sleeves made of a chemically resistant material, preferably plastic, e.g. polypropylene.

The subject of the invention is a method and device for extracting substances from a specific zone/spot of a substance in the adsorbent layer on a chromatographic plate, which zone/spot, obtained after developing the chromatogram, contains in its area one or more components originating from the separated mixture. The extract obtained can be used for qualitative and/or quantitative analysis using instrumental techniques.

In laboratory practice, the simplest extraction of substances from the adsorbent layer of a chromatographic plate is performed by scraping off a certain zone of this layer in which the substance or mixture of substances is located, transferring it to a filter paper filter screen placed on a funnel and washing out the substance with a suitable solvent. The obtained extract solution is subjected to further processing depending on the purpose for which it is to be used, e.g. for quantitative or qualitative analysis or for preparative purposes. This method is described in the monograph on thin-layer chromatography, Thin-Layer Chromatography, Fourth Edition, Revised and Expanded, B. Fried, J. Sherma, 1999, Marcel Dekker, Inc., Chapters 10 and 12.

In the publication B. Falk and K Krummen, J. Chromatogr. A, 103 (1975), 279-288 a method and apparatus for eluting substances from their spots on a chromatographic plate are described. The essence of the method and device consists in creating a groove in the form of a circle in the adsorbent layer around the spot, pressing the Teflon head with a seal to this groove and supplying the elution solvent using a syringe pump to one opening in the head and collecting the leakage through another opening. An appropriately selected solvent flows through the zone of the adsorbent layer limited by the aforementioned seal, eluting substances from it. Using the device, substances can be simultaneously eluted from six substance spots in the adsorbent layer of the chromatographic plate. The disadvantage of the device is the need to manually make a groove in the adsorbent layer for the seal located in the head and to rinse the device before the next elution process. In addition, it is necessary to use a syringe pump, which additionally increases the cost of the device.

A device for eluting substances from the adsorbent layer on the chromatographic plate is known, presented in the publication by H. Luftmann, Anal. Bioanal. Chem. (2004) 378:964-968, DOI 10.1007/s00216-003-2293-3 and in patent description DE10036293A1. This device is constructed in the form of a steel piston provided on its lower surface over its entire circumference with a sharp edge and two capillary channels, one for supplying and the other for discharging the extracting liquid. The supply of the extracting liquid is carried out by means of a pressure pump. In order to wash out the substance from the adsorbent layer, the said piston is pressed against this layer and the eluting liquid is pressed by means of a pressure pump through the supply channel, the adsorbent layer and the discharge channel. From the latter channel, the liquid with the eluted substance/substances is directed to vials or directly to the device for instrumental analysis. The disadvantage of the presented solution is the frequent clogging of the device channels with adsorbent particles, the need to wash it thoroughly before the next elution process from the next place in the adsorbent layer on the chromatographic plate and the need to use a pressure pump, which is usually an expensive device. This solution consumes a lot of elution liquid, and in addition, the obtained sample is diluted and sometimes requires concentration for further stages.

According to the U.S. Pat. No. 5,208,458 dated May 4, 1993, a device is known that connects planar electropherograms of various types, including gel electropherograms, with a mass spectrometer. The connecting device consists of a pump that delivers a solvent at a specified speed to the surface of the electropherogram, a system for breaking/crumbling the gel and releasing the molecules of substances contained therein so that they can be absorbed by the solvent and a capillary that transfers the volume of solvent containing eluted substances to the mass spectrometer. The limitation of this device is its intended use for electrophoregrams, from which substances are eluted into the mass spectrometer. In addition, the elution solvent must be supplied by a separate pump, connected to the sample injector of the mass spectrometer, which makes the device complex, relatively expensive, and prone to clogging of the connecting channels.

Another solution is described in patent application US 2011/0269166 A1 dated Nov. 3, 2011. The sample located in the absorption layer, acting as a filter layer, is placed on a flexible hydrophobic substrate. The sample may contain biological or chemical material and an absorption/filtering material/layer. The filter layer contains an absorption material in which the sample material is embedded. The sample is collected using a sampler that adheres its surface to the absorption material. The sampler is provided with a sharp edge that is pressed against the hydrophobic substrate, which ensures tight connection of the sampler with the flexible hydrophobic substrate and flow of the elution solvent under pressure through the absorption material/filtering layer. The sampler has 2 supply and discharge channels. The sample is eluted from the absorption layer by means of an additional pump that forces the eluting solvent into the supply channel, then through the absorption/filter layer and out of the sampler through the discharge channel. The effluent from the discharge channel can be collected in vials/vials or introduced directly into the instrumental analysis device. The sampler has some disadvantages, such as clogging of the discharge channel, it is necessary to wash/clean the sampler after each sample elution process, and the use of an additional pump increases the cost of using the sampler.

On May 24, 2012, a patent application was published under the number US 2012/0125127 A1, which describes a device for preparing samples for qualitative and quantitative instrumental analysis. This device allows for the closure of a porous material containing adsorbed sample components in a chamber formed between two compressed blocks. The connection between the squeezed blocks is tight, which allows for the supply of eluting solvent under pressure to the material enclosed in the aforementioned chamber and elution of the substance into vials or into the instrumental analysis device. This device must be connected to a pressure pump, which significantly increases its cost. In addition, the channels of the device may become clogged with particles of porous material during use of the device, and the aforementioned chamber and channels of the device require thorough washing for cleaning before each subsequent use for a new sample.

The purpose of the solution according to the invention is to provide a device for extracting substances from the adsorbent layer of the chromatographic plate, in which the channels of the device will not become clogged with adsorbent particles. In addition, the purpose of the invention is to provide a device that is easy to use, does not require washing the device before the next elution process from the next place in the adsorbent layer on the chromatographic plate, and a device that does not require the use of a pressure pump, which is usually an expensive device. In addition, the aim of the solution is to provide a device that will require small amounts of eluting liquid, and the obtained sample will not be too diluted and its concentration will not be required for further stages. The proposed invention solves the problem of extracting a substance from a specific place in the adsorbent layer of the chromatographic plate. The essence of the method of extracting a substance from a specific place, a zone/spot containing the substance/s, usually after developing the chromatogram, in the adsorbent layer of the chromatographic plate consists in using a small capacity sleeve with a specially profiled, sharply terminated tip, which is pressed with a small force perpendicularly through the adsorbent layer to the carrier plate of the adsorbent layer (the carrier plate with the adsorbent layer is called the chromatographic plate). The chromatographic plate with the sleeve pressed against it forms a microvessel, the bottom of which is the carrier plate of the adsorbent layer, and the wall of this microvessel is the wall of the sleeve. According to the proposed invention, a specified small volume of extracting liquid is introduced into the formed microvessel through the upper opening of the sleeve using a syringe or pipette, then the extracting liquid is kept in contact with the adsorbent layer for a specified short time. Then the extracting liquid with the substances extracted using a syringe or pipette is withdrawn from the microvessel. The obtained extract solution is placed in vials and subjected to the process of sedimentation of solid particles of the adsorbent layer or, before placing in vials, solid particles are removed from it using filtration or centrifugation and sent for instrumental analysis.

A method for extracting a substance from the adsorbent layer of a chromatographic plate/from a specific location in the adsorbent layer of a chromatographic plate is characterized in that it comprises the following steps:
creating a microvessel between the carrier plate of the chromatographic plate and a sleeve pressed against it, wherein the sleeve is pressed at a right angle to the carrier plate of the adsorbent layer, so that the bottom is the carrier plate of the adsorbent layer, and the wall of this microvessel is the wall of the sleeve, wherein the height of the microvessel is preferably up to 50 mm. The carrier plate with the adsorbent layer is called a chromatographic plate. The chromatographic plate with the sleeve pressed against it forms a microvessel, the height of which is preferably up to 50 mm, even more preferably between 5 mm and 50 mm, and even more preferably between 10 mm and 50 mm,
introducing a specified small volume of extracting liquid into the created microvessel through the upper opening of the sleeve, with a volume of more than 20 μL, preferably between 20 μL and 500 μL. The use of such a volume (preferably above 20 μL) of extracting liquid enables free collection of liquid with a pipette from above the adsorbent layer. At the same time, some of the liquid is not absorbed into the adsorbent layer,
The extracting liquid can be advantageously introduced using a syringe or pipette, in an amount of several dozen to several hundred microlitres,
maintaining the extracting liquid in contact with the adsorbent layer in the microvessel for a specified short time in the range of 1 min to 10 min. The time of maintaining the extracting liquid in contact with the adsorbent layer can be advantageously from 10 seconds to 10 minutes, with the time preferably being about 10 seconds to 1 minute for screening analyses. The incubation time can also be from 1 min to 10 min,
withdrawing the extract (i.e. extracting liquid with extracted substances) from the microvessel. The liquid is advantageously removed from the microvessel using a syringe or pipette.

Preferably, the method is characterized in that in subsequent stages the extract is directed to instrumental analysis, or before being directed to instrumental analysis, solid particles of the adsorbent layer are separated from the extract.

Preferably, the method according to the invention is characterized in that it comprises a step of removing solid particles of the adsorbent layer, wherein the solid particles are removed from the adsorbent layer before being placed in vials using filtration or centrifugation, or the solid particles are removed after being placed in vials by subjecting the solid particles to a sedimentation process.

Preferably, the method according to the invention is characterized in that the microvessel has an internal opening in the shape of a circle with an internal diameter of preferably from 2 mm to 10 mm or in the shape of an oval with a dimension of the shorter axis of preferably from 2 mm to 6 mm and a longer axis of 3 mm to 10 mm.

Preferably, the method according to the invention is characterized in that a part of the introduced extracting liquid is withdrawn from the microvessel and immediately reintroduced into the microvessel, repeating the operations of withdrawing and introducing said part of the extracting liquid from 2 to 10 times.

Preferably, the method according to the invention is characterized in that the extraction process is preferably repeated several times with a new portion of the extracting liquid, the obtained extract solutions are combined, and the number of extraction repetitions is determined experimentally.

A specific amount of the extracting liquid is introduced into the microvessel and preferably a part of it is withdrawn from the microvessel and immediately reintroduced into the microvessel using a syringe or pipette, repeating the operations of withdrawing and introducing said part of the liquid several times in short time intervals. The number of these operations, withdrawing and introducing a part of the extracting liquid, is determined experimentally, and the duration of these operations of withdrawing and introducing the extracting liquid is also determined experimentally. Immediate withdrawal and introduction of the extracting liquid replaces mixing. During the discharge and introduction, the same liquid is advantageously used, which mixes it and accelerates the extraction and the establishment of thermodynamic equilibrium.

As an alternative to performing the above-mentioned operations of repeatedly removing and introducing a part of the extracting liquid, the extracting liquid in the microvessel is stirred.

The method according to the invention is advantageously characterized in that the extracting liquid in the microvessel is stirred, advantageously with a miniature stirrer or by shaking or ultrasound.

A method of extracting substances from a chromatographic plate according to claim 1 is advantageously characterized in that the time of one extraction process is up to 10 minutes, and is advantageously determined experimentally.

A method according to the invention is advantageously characterized in that during the extraction process, the upper opening of the sleeve is advantageously closed with a plug/cork with an opening.

The statement “during the extraction process” is equivalent to the statement “during the extraction process” or “during extraction”. This means that the substances pass from the adsorbent layer to the extracting solvent.

A device for extracting a substance from a chromatographic plate comprising a body and a tabletop for placing the chromatographic plate, characterized in that it comprises:
a component connected to the body for securing at least one sleeve in the form of a holder and/or a fastening beam,
a pressure mechanism connected to the body of the device ensuring perpendicular pressing of at least one sleeve to the chromatographic plate and enabling the displacement of at least one sleeve from the chromatographic plate,
an elastic element ensuring the adjustment of the edge of the sleeve to the chromatographic plate.

The body may be a single-element or multi-element element.

The tabletop evenly supports the chromatographic plate in the places where the extraction is performed, and the tabletop may be integrated with the body (as one element), or the tabletop may be an additional element connected directly or indirectly to the body.

In the case where it is connected directly to the body, the pressing mechanism moves with the sleeves to the chromatographic plate placed on the tabletop. In the case where the pressing mechanism is located under the tabletop, the tabletop together with the chromatographic plate are moved and pressed against the sleeves. The tabletop may be connected directly to the body, it may be integrated with it (it may be part of the body), or the tabletop may be connected to the body indirectly, for example through a pressing mechanism.

The fastening element allows for interchangeable and vertical fastening of at least one sleeve. The sleeves may be mounted in a holder connected, for example, to the beam of the body/frame, or mounted directly in the pressing beam. The method of attaching the sleeve to the holder can be any, provided that a stable connection and even attachment of the sleeve are ensured.

The holder can be equipped with a snap mechanism holding the sleeve, and the holder can be connected to the pressing mechanism via elastic elements.

The role of the sleeve holder is also played by an element in the form of a mounting beam, preferably equipped with O-rings mounted in the pressing beam, which hold at least one sleeve. The shape of the mounting beam can be any and the arrangement of the elements holding the sleeve can be any.

The pressing mechanism ensures perpendicular pressing of at least one sleeve to the chromatographic plate and allows the sleeve/sleeves to be moved away from the chromatographic plate to a distance necessary for their easy replacement, i.e. lifting the sleeve/sleeves at least a few mm above the chromatographic plate.

The pressing mechanism may be connected to the body of the device directly or indirectly, wherein the pressing mechanism may be located under the table top and lift the table top with the chromatographic plate to at least one sleeve, or be attached to an element securing at least one sleeve and then move this mechanism with the sleeves to the chromatographic plate.

The pressing mechanism may regulate the pressing force by means of a turnbuckle, or may include an additional element regulating the pressing force using a system controlling the operation of the pressing mechanism based on readings from strain gauge sensors.

The elastic element ensures that the edge of the sleeve is adjusted to the chromatographic plate. The elastic element is, for example, a pair of elastomers connected to the pressing mechanism.

Alternatively, the elastic element is O-rings, which additionally perform the function of securing the sleeves.

Advantageously, the device according to the invention is characterized in that it has at least one replaceable sleeve made of a chemically inert material, preferably plastic, which is sharply terminated along the entire circumference of the lower edge, and the sharp end is formed by a connection of two surfaces of the sleeve, the outer surface of the sleeve and the surface of the inner chamfer of the sleeve, or the edge is formed by two surfaces: one being the surface of the inner wall of the sleeve and the other being the surface of the chamfer from the bottom of the sleeve on its outer side, or the edge is formed by the surfaces of the outer chamfer and the inner chamfer.

Advantageously, the device for extracting substances from a chromatographic plate is characterized in that the angle between the surfaces forming the sharp end of the edge is sharp and ranges from 15° to 70°.

The sleeve with a sharp edge according to the invention enables even pressing on the circumference and achieving tightness of the connection of the sleeve with the chromatographic plate carrier plate.

Advantageously, the device is characterized in that the edge formed at the point of connection of the outer surface of the sleeve with the surface of the inner chamfer of the sleeve has a blunting along the entire circumference, and advantageously the width of this blunting surface is from 0.1 to 0.5 mm.

Advantageously, the device is characterized in that the sleeve has at least one hole with a diameter advantageously in the range from 0.3 to 1.5 mm in the wall of the sleeve near the end opposite the end of the sleeve provided with a sharply ended edge.

This opening is optional and serves to equalize the pressure inside the sleeve with the external pressure when a pipette inserted into the sleeve adapts to it and draws out the solution. It can be used as one of the options when using a manual extractor, because users can use different pipettes. In the case of an automatic extractor, however, a standard pipette will be used, so the presence or absence of the opening is less important.

Preferably, the device is characterized in that the sleeve has at least one longitudinal groove in the wall on the inside, starting from the end of the sleeve opposite the end of the sleeve provided with a sharp edge, up to 10 mm long, 0.3-1.0 mm wide and 0.3-0.6 mm deep.

Advantageously, the device is characterized in that the internal cross-section of the sleeve has the shape of a circle with a diameter of preferably 2 to 10 mm, or the internal cross-section of the sleeve has the shape of an oval with a shorter axis preferably in the range of 2 to 6 mm and a longer axis preferably in the range of 3 to 10 mm, or the internal cross-section of the sleeve has a shape close to a circle or oval.

Advantageously, the device is characterized in that the sleeve has a length of up to 50 mm, preferably between 5 mm and 50 mm, and even more advantageously between 10 mm and 50 mm.

Advantageously, the device is characterized in that the sleeve is provided on its external surface with one protrusion/collar or two protrusions/collars on its entire circumference, or has a recess/groove or two grooves/recesses on its entire circumference.

Advantageously, the device is characterized in that the sleeve advantageously has a plug for the hole opposite the sleeve hole with a sharp edge, and said plug is equipped with a hole with a diameter of up to 2 mm.

Advantageously, the device is characterized in that the handle is equipped with a snap mechanism holding the sleeve, wherein the handle is connected to the pressing mechanism via elastic elements.

Advantageously, the device is characterized in that the sleeve holder is an element in the form of a fastening beam, advantageously equipped with O-rings that hold the sleeve.

Advantageously, the device is characterized in that the element of the pressing mechanism is a turnbuckle.

Advantageously, the device is characterized in that the pressing mechanism comprises a turnbuckle allowing for force adjustment, a lever, an upper pressing plate, a lower pressing plate connected to an elastic element, advantageously a pair of elastomers that connect the pressing mechanism to the sleeve holder.

The lever can be operated by the operator. In such a solution, thanks to the use of such a pressing mechanism, the holder together with the sleeves moves to the chromatographic plate.

Preferably, the device is characterized in that the pressing mechanism is connected to the mounting beam via strain gauge sensors and ensures the displacement of the beam mounting at least one sleeve and the pressing of at least one sleeve to the chromatographic plate, or the pressing mechanism is connected to the tabletop also via strain gauge sensors and ensures the displacement of the tabletop with the chromatographic plate to at least one sleeve.

Preferably, the device is characterized in that it includes an additional element regulating the pressing force using a system controlling the operation of the pressing mechanism based on readings from the strain gauge sensors.

Connecting the holder/beam via strain gauge sensors to the pressing mechanisms allows for the pressing of at least one sleeve to the chromatographic plate 8 with a controlled force.

Advantageously, the device is characterized in that the top is connected directly to the body, or the top is connected to the pressing mechanism via strain gauge sensors, wherein the pressing mechanism is connected to the body.

Advantageously, the device is characterized in that the fastening beam is connected to the rotation mechanisms enabling the beam/sleeves to be rotated by 180°.

The beam fastening the sleeves and the beam of the body/frame may be mounted in a rotatable manner, which in particular facilitates the replacement of the sleeves.

Advantageously, the device is characterized in that the elastic element is a pair of elastomers placed in the pressing mechanism and/or the elastic element is an O-ring which simultaneously fastens the sleeves.

Advantageously, the device is characterized in that it is equipped with a rigid frame top equipped with two rigid supports on opposite sides, to which a rigid frame beam is horizontally attached above the rigid top and includes a sleeve holder, in which the sleeve is interchangeably and vertically attached, and two elastic washers with a thickness of several mm are attached to the sleeve holder from the top on both its left and right sides, to which the lower pressure plate is attached from the top, and a turnbuckle is attached to the lower pressure plate from its upper side with one of its ends, and the turnbuckle is attached with its other end to the upper pressure plate, which is connected to the arm of the pressure lever attached to the frame beam, and the lower pressure plate is slidably connected vertically to the frame beam, wherein the distance of the lower pressure plate from the upper pressure plate is regulated by the range of shortening/lengthening of the turnbuckle, and the movement of the lower pressure plate is limited to the distance between a lower limiting strip and an upper limiting strip, which are attached to the frame beam, and between the lower limiting strip and the lower pressure plate there are two springs placed to support the upward movement of the lower pressure plate, and together with it the sleeve holder with the sleeve, the turnbuckle and the upper pressure plate, when the pressure lever arm is raised. The sleeve has a length of preferably 10 to 50 mm.

The sleeve is provided on its external surface with one protrusion/flange or two protrusions/flanges on its entire circumference.

Preferably, the sleeve has a plug for the opening opposite the sleeve opening with a sharp edge, and said plug is provided with a hole with a diameter of preferably up to 2 mm.

In a device for extracting substances from a chromatographic plate, placed with the adsorbent layer upwards on a rigid frame top, equipped on opposite sides of the rigid top with two rigid supports, to which a rigid frame beam is attached horizontally above the rigid top, the device presses the sleeve perpendicularly to the chromatographic plate and lifts it above the chromatographic plate. The sleeve is made of a chemically inert material, preferably plastic, e.g. polypropylene, and is interchangeably placed in a sleeve holder connected to a mechanism for perpendicularly pressing the sleeve to the chromatographic plate from the side of the adsorbent layer and lifting the sleeve above the adsorbent layer by at least a few mm. The sleeve holder is connected to a flexible pressure pad of a few mm thickness, to which the lower pressure plate is attached, slidably connected vertically to the frame beam and connected via a turnbuckle to the upper pressure plate, and this to the arm of the pressure lever attached to the frame beam. The pressure lever arm exerts pressure successively on the upper pressure plate, the turnbuckle, the lower pressure plate, the flexible pressure pad, the sleeve holder and the sleeve, which is directly pressed with its sharp edge to the chromatographic plate. The frame beam is fitted with lower and upper limiting strips which limit the movement of the lower pressure plate. Two springs are located between the lower pressure plate and the lower limiting strip, on the left and right, which support the upward movement of the lower pressure plate when the pressure lever arm is raised. Then, together with the lower pressure plate, the sleeve holder, the sleeve, the turnbuckle and the upper pressure plate are raised. The distance between the lower pressure plate and the upper pressure plate and thus the force of the sleeve pressing against the chromatographic plate is adjusted using the turnbuckle. The lower end of the sleeve, which is in direct contact with the chromatographic plate, is provided with a sharp edge along its entire circumference, formed by the outer surface of the sleeve and the surface of the inner chamfer of the sleeve. The angle between the aforementioned surfaces is acute and ranges from 15° to 70°. The solution according to the invention has many advantages. The solution according to the invention is characterized by very simple and reliable operation and does not require the use of an expensive liquid pump. Each extraction process from a specific place on the chromatographic plate is carried out using at least one sleeve. The sleeves are easily mounted and removed from the device. Extraction from another place on the chromatographic plate is carried out using a new/clean sleeve. The sleeve/sleeves can be used once or used many times after cleaning/washing. The device does not require washing/cleaning before the next extraction process. Very small amounts of extracting liquid are used for extraction, from several dozen to several hundred microlitres, which makes it very economical and environmentally friendly. The use of an elastic pressure pad in the device allows for even pressing and adjusting the lower edge of the sleeve to the chromatographic plate, which facilitates the tightness of the connection between the sleeve and the carrier plate of the adsorbent layer. The proposed shape of the sharp edge of the sleeve allows for easier sealing with the chromatographic plate, because at the point of contact of this edge with the chromatographic plate, when it is pressed to the chromatographic plate, the sharp edge increases its diameter minimally, which causes its minimal movement on the carrier plate and thus a slight movement of the adsorbent layer and thanks to this, the adsorbent grains are removed from the point of contact of the sharp edge with the carrier plate of the adsorbent layer, which allows for obtaining tightness by using a relatively small force of pressing the sleeve to the chromatographic plate. In addition, the extraction process in the device takes place under atmospheric pressure and thanks to this also contributes to the use of a small force of pressing the sleeve to the adsorbent layer in order to seal the point of contact of the sharp edge of the sleeve with the carrier plate of the adsorbent layer.

The solution according to the invention is also easy to use, does not require rinsing the device before the next elution process from the next place in the adsorbent layer on the chromatographic plate and does not require the use of a pressure pump. In addition, the solution provides a device that requires small amounts of elution liquid, and the obtained sample is not too diluted and its concentration is not required for further stages.

The subject of the invention in a non-limiting example of implementation is shown in the drawing, in which the individual figures show:

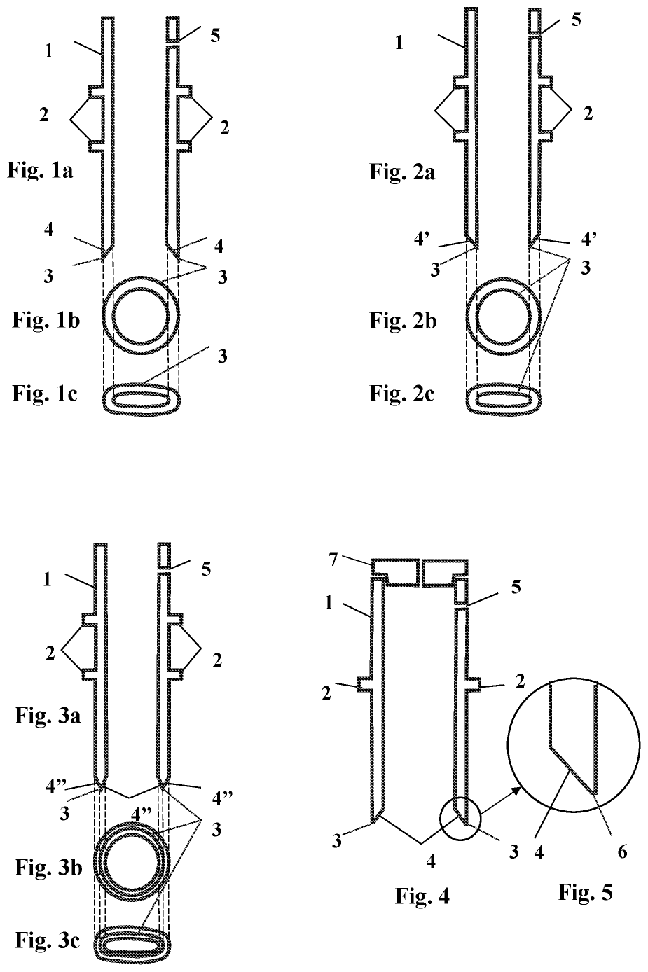

FIG. 1a. Diagram of a sleeve with an internal hole in the shape of a circle or oval with a sharply ended lower edge on the outer wall of the sleeve in a longitudinal vertical section.

FIG. 1b. A sleeve with an internal hole in the shape of a circle with a sharply ended lower edge on the outer wall of the sleeve in a cross-section from the bottom.

FIG. 1c. A sleeve with an internal hole in the shape of an oval with a sharply ended lower edge on the outer wall of the sleeve in a cross-section from the bottom.

FIG. 2a. Diagram of a sleeve with a circular or oval shaped internal hole with a sharply ended lower edge on the inner wall of the sleeve in a longitudinal vertical section,

FIG. 2b. A sleeve with a circular shaped internal hole with a sharply ended lower edge on the inner wall of the sleeve in a cross-section from below.

FIG. 2c. A sleeve with an oval shaped internal hole with a sharply ended lower edge on the inner wall of the sleeve in a cross-section from below.

FIG. 3a. Diagram of a sleeve with a circular or oval shaped internal hole with a sharply ended lower edge between the outer and inner walls of the sleeve in a longitudinal vertical section,

FIG. 3b. A sleeve with a circular shaped internal hole with a sharply ended lower edge between the outer and inner walls of the sleeve in a cross-section from below.

FIG. 3c. Sleeve with an internal hole in the shape of an oval with a sharply ended lower edge between the outer and inner walls of the sleeve in a cross-section from the bottom.

FIG. 4. Schematic diagram of a sleeve variant with a blunted lower edge with a sharply ended edge and with a top hole plug in a longitudinal vertical section,

FIG. 5. Schematic diagram of an enlarged fragment of the sleeve from FIG. 4 with a blunted lower edge with a sharply ended edge on the outer wall of the sleeve in a longitudinal vertical section,

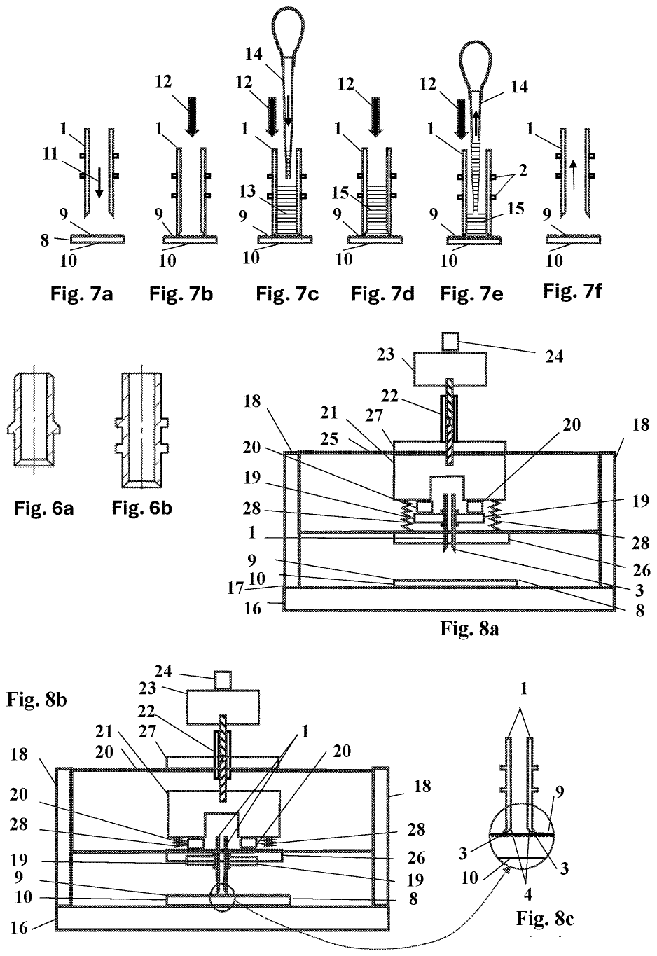

FIG. 6a. Example of sleeves in a cross-section with the internal geometry and the beveled upper edge marked.

FIG. 6b. Example of sleeves in a cross-section with the internal geometry marked.

FIG. 7a-f. The essence of the method of performing extraction from the adsorbent layer on a chromatographic plate.

FIG. 8a. Schematic diagram of the device with a sleeve above the chromatographic plate in a front view in one of the variants of execution.

FIG. 8b. Schematic diagram of the device with the sleeve pressed against the chromatographic plate in the front view.

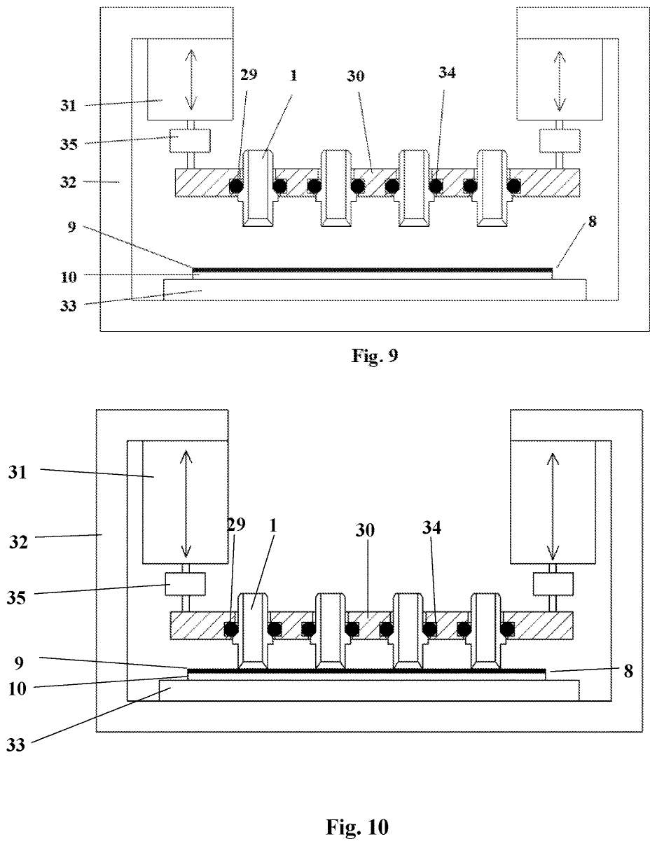

FIG. 9. View of variant 2 of the device from its front during the extraction process. Elements such as the pressure beam, sleeves and O-rings have been presented in the form of a cross-section in the plane of all sleeve axes.

FIG. 10. View of variant 2 of the device from its front in a state allowing for the replacement of sleeves. Elements such as the pressure beam, sleeves and O-rings have been presented in the form of a cross-section in the plane of all sleeve axes.

FIG. 11. A view of the third variant of the device showing the state of the device in which the pressure beam is rotated by 180 degrees. In this state, the sleeves can be easily attached or dismantled. This is an auxiliary drawing that shows the principle of operation of the pressure beam rotation mechanism.

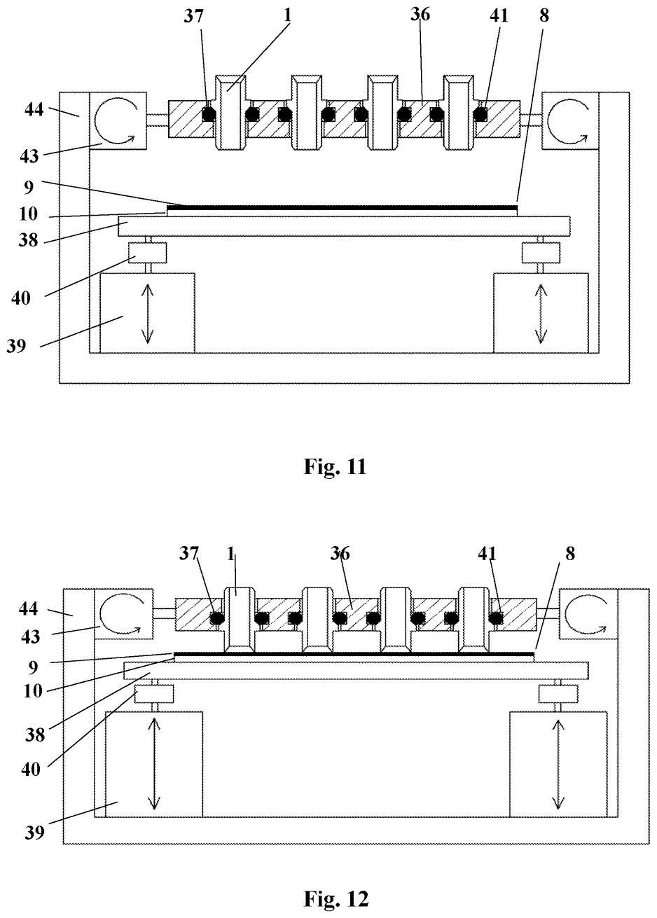

FIG. 12. A view of the third variant of the device during extraction. The drawing shows the view of the device from its front. Elements such as the pressure beam, sleeves and O-rings are shown in the form of a cross-section in the plane of all axes of the sleeves.

### EXAMPLE 1

In the first non-limiting example of the embodiment, FIG. 1a. shows a diagram of a sleeve 1 with an internal hole in the shape of a circle or oval in a vertical longitudinal section. The sleeve is made of polypropylene. The internal diameter of the sleeve 1 is 4.5 mm, the external diameter is 6.5 mm and its length is 25 mm. On the outer wall, the sleeve 1 has two protrusions 2 with an outer diameter of 10 mm and a thickness of 1.6 mm along its entire circumference. The purpose of the protrusions is to ensure that the sleeve is stably, easily and every time identically/repeatable placed in the sleeve holder of the device. The sleeve 1 is equipped, at its lower end, along the entire circumference of the outer wall with a sharp edge 3. This edge is formed by two surfaces: one constituting the surface of the outer wall of the sleeve and the other constituting the surface of the chamfer 4 from the bottom of the sleeve on its inner side. Both of these surfaces are positioned relative to each other at an angle of 45°. In addition, the sleeve 1 is equipped in its upper part with a hole 5 with a diameter of 1 mm. The hole in the side wall of the sleeve serves to equalize the pressure inside the sleeve with the external pressure in the event that the inserted pipette adheres tightly to the inner wall of the sleeve. Then, when pulling/sucking out the solution from the sleeve, a vacuum would be created, which would prevent the removal of all the solution. This side hole prevents this effect.

The sleeve (made of plastic), preferably polypropylene, makes it cost-effective. This plastic is flexible to a certain extent, which allows for easy adjustment to the surface of the glass carrier plate and thus sealing with less pressure.

If the sleeve is made of acid-resistant steel, then it requires greater pressure on the glass carrier plate. However, if the carrier plate is plastic or aluminum, then the steel sleeve easily seals with the carrier plate.

In an alternative embodiment, the sleeve can be made of acid-resistant steel and other plastics, e.g. polyetheretherketone (PEEK).

### EXAMPLE 2

In the second embodiment shown in FIG. 2a., the sleeve 1 has an internal hole in the shape of a circle or oval, wherein the sleeve 1 has a sharp edge 3 at the bottom of the inner wall from the bottom. The sleeve 1 is equipped, at its lower end along the entire circumference of the outer wall, with a sharp edge 3. This edge is formed by two surfaces: one constituting the surface of the inner wall of the sleeve and the other constituting the surface of the chamfer 4′ from the bottom of the sleeve on its outer side. The sleeve is made of polypropylene. In another variant, it is made of acid-resistant steel, or in another variant, of polyetheretherketone (PEEK).

In the variant shown in FIG. 2b, a view of the sleeve with an internal hole in the shape of a circle is shown in cross-section from the bottom. FIG. 2b shows the inner hole of the sleeve in the shape of a circle and the sharp edge 3 at the bottom of the inner wall also in the shape of a circle. In an alternative variant, shown in FIG. 2c, a view of the sleeve with the inner hole in the shape of an oval is shown in cross-section from below. The drawing shows the inner hole of the sleeve in the shape of an oval and the sharp edge 3 at the bottom of the inner wall also in the shape of an oval.

### EXAMPLE 3

In the third embodiment of the sleeve shown in FIG. 3a, the sleeve 1 has an internal hole in the shape of a circle or an oval, wherein the sleeve 1 has a sharp edge 3 at the bottom located between the outer and inner walls of the sleeve 1. This edge is formed by the surfaces of the outer chamfer 4″ and the inner chamfer 4″. The sleeve is made of polypropylene.

In the embodiment shown in FIG. 3b, showing a view of the sleeve with an internal hole in the shape of a circle in cross-section from below, the inner hole of the sleeve in the shape of a circle and the sharp edge 3 in the shape of a circle at the bottom of the sleeve 1 between the outer and inner walls are visible.

An alternative variant is shown in FIG. 3c, showing a view of the sleeve with an internal hole in the shape of an oval in cross-section from below. The drawing shows an oval-shaped internal hole of the sleeve and an oval-shaped sharp edge 3 at the bottom of the sleeve 1 between the outer and inner walls.

### EXAMPLE 4

The drawing, FIG. 4, shows a sleeve 1, the sharp edge 3 of which is provided with a blunting 6 of the junction of the chamfer surface 4 and the outer surface of the sleeve wall 1 over the entire circumference, FIG. 5. This blunting has a width of 0.1 mm. The blunting surface forms a right angle with the outer surface of the sleeve wall and an angle of 135° with the chamfer surface 4 on the inner side of the sleeve 1. Near the upper end of the sleeve, opposite the lower end provided with a sharp edge 3, a hole 5 with a diameter of 1 mm is located in the sleeve wall.

The sleeve 1 may be without a plug or with a plug 7 of the hole opposite the sleeve hole with a sharp edge 3. In this variant, the plug 7 is provided with a hole with a diameter of up to 2 mm.

The blunting can also be made for any type of sleeve described in this application.

The plug can also be present in other variants of the sleeve.

### EXAMPLE OF THE METHOD

In a non-limiting example of the embodiment, FIG. 7a-f. shows a method of extracting a substance from a chromatographic plate.

According to the proposed invention, in the first step, a microvessel is produced between the carrier plate of the chromatographic plate and the sleeve pressed against it, wherein the sleeve is pressed at a right angle to the carrier plate of the adsorbent layer, so that the bottom is the carrier plate of the adsorbent layer and the wall of this microvessel is the wall of the sleeve. As shown in the drawing, in order to produce a microvessel, the sleeve 1 is lowered perpendicularly to the chromatographic plate 8 with the adsorbent layer 9 and the glass carrier plate 10, FIG. 7a., at the location of the adsorbent layer 9 where the spot of the substance to be extracted is located. The arrow 11 shows the direction of lowering the sleeve 1 into the adsorbent layer 9 until it comes into contact with the adsorbent layer 9, after which the sleeve 1 is pressed perpendicularly with a sharp edge and a small pressing force, illustrated by the arrow 12, allowing direct contact and tightness of the connection of the sharp edge 3 of the sleeve 1 with the glass carrier plate 10, FIG. 7b. In this way, a microvessel is formed, the wall of which is the wall of the sleeve 1, and the glass carrier plate 10 constitutes the bottom of this microvessel. The carrier plate 10 with the adsorbent layer 9 is called the chromatographic plate 8. The chromatographic plate 8 with the sleeve 1 pressed against it forms a microvessel. In a preferred embodiment, the height of the microvessel is up to 50 mm, with an internal opening in the shape of a circle. The dimensions of the microvessel can be any, but preferably with an internal diameter of preferably from 2 mm to 10 mm or in the shape of an oval with the dimension of the shorter axis preferably from 2 mm to 6 mm and the longer axis of 3 mm to 10 mm. In the next step, a specified small volume of extracting liquid 13 is introduced into the formed microvessel through the upper opening of the sleeve. The extracting liquid 13 is introduced using a syringe or pipette 14 in an amount of 20 μL to 500 μL, FIG. 7c. The extracting liquid was kept in contact with the adsorbent layer 9 in the microvessel for a specified short time from 1 minute to 10 minutes FIG. 7d., after which time the extract solution 15 (i.e. the extracting liquid with the extracted substances) was withdrawn from the microvessel. Preferably the liquid was removed from the microvessel by means of a syringe or pipette 14, FIG. 7e. Then the obtained extract 15 was transferred to vials for instrumental analysis. In an alternative example, prior to transfer to the vials the solid particles were separated by filtration. After the extract 15 had been withdrawn from the microvessel the sleeve 1 was released from the pressing force, illustrated by arrow 12, and lifted from above the adsorbent layer, FIG. 7f. To perform extraction from the next location in the adsorbent layer of the chromatography plate, a new sleeve 1 was used or the used one was cleaned and reused for the extraction process.

### EXAMPLE OF THE METHOD 2

In the second embodiment of the method, a specific amount of extracting liquid 13 is introduced into the microvessel and preferably a part of it is withdrawn from the microvessel and immediately reintroduced into the microvessel using a syringe or pipette 14, repeating the operations of withdrawing and introducing said part of the liquid several times in short time intervals. The number of these operations of withdrawing and introducing a part of the extracting liquid is determined experimentally, and the duration of these operations of withdrawing and introducing the extracting liquid is also determined experimentally.

As an alternative to performing the above-mentioned operations of withdrawing and introducing a part of the extracting liquid several times, the extracting liquid in the microvessel is stirred.

### EXAMPLE OF THE DEVICE 1

In the drawing, FIG. 8a., an example device is schematically shown, with a sleeve 1 above a chromatographic plate 8 consisting of two parts: an adsorbent layer 9 and a carrier plate 10, being a mechanism perpendicularly pressing the sleeve 1 to the chromatographic plate placed on a rigid top of the frame 16. The body/frame of the device 17 is formed by the top 16 and the supports 18 attached to the top 16 and the frame beam 25 attached to the supports 18. In this example of embodiment, the sleeve 1, made of polypropylene, is held by a fastening element in the form of a handle 19, at a distance of about 10 mm of the lower edge 3 of the sleeve 1 from the adsorbent layer 9. The holder 19 of the sleeve 1 is connected to a flexible pressure pad 20 with a thickness of 5 mm, directly on it there is a lower pressure plate 21 connected by a turnbuckle 22 to an upper pressure plate 23. An arm 24 of a pressure lever is attached to the upper pressure plate 23. The pressure lever is not shown, it is not visible, because it is on the back of the device presented in FIG. 8a. The lever is attached from the back to the frame beam 25. From the front, only the lever frame 24 is visible. The lower pressure plate 21 is vertically slidably connected to the frame beam 25, and the movement of the lower pressure plate 21 relative to the frame beam 25 is limited to the distance between the lower limiting strip 26 and the upper limiting strip 27, which are attached to the frame beam 25. Two springs 28 are arranged between the lower limiting strip 26 and the lower pressure plate 21 to assist in the upward movement of the lower pressure plate 21 and, together with it, the sleeve holder 19 with the sleeve 1, the turnbuckle 22 and the upper pressure plate 23 when the pressure lever arm 24 is raised. Two rigid supports 18 are attached to the rigid table top 16 on its opposite sides, and the frame beam 25 is horizontally attached above the rigid table top 16 of the frame to the two rigid supports 18 (the lower pressure plate 21 and the lever with the pressure arm 24 are slidably attached vertically to the frame beam 25).

The drawing, FIG. 8b. shows an exemplary device, as in FIG. 8a., in the situation of pressing the sleeve 1 to the chromatographic plate 8 placed on the rigid table top 16 of the frame. In the drawing, the arm 24 of the pressure lever exerts pressure successively on the upper pressure plate 23, the turnbuckle 22, the lower pressure plate 21, the elastic pressure pad 20, the sleeve holder 19 and the sleeve 1, which is pressed perpendicularly with its edge bottom to the chromatographic plate. FIG. 8b. shows the deformation of the elastic pressure pad 20 under the influence of the pressure force. Thanks to the elastic pressure pad 20, the contact of the lower edge 3 of the sleeve 1 with the glass carrier plate 10 is carried out with the same force over the entire circumference of the aforementioned edge 3 of the sleeve 1. The force of pressing the sleeve to the chromatographic plate is adjusted by means of the turnbuckle 22. The lower end of the sleeve 1, which is directly in contact with the chromatographic plate 8, is provided with a sharp edge 3 over the entire circumference, formed by the outer surface of the sleeve 1 and the surface of the chamfer 4 of the inner sleeve 1. The angle between the aforementioned surfaces is acute and amounts to 45°. The drawing, FIG. 8c., shows an enlarged lower part of an exemplary sleeve 1 and a chromatographic plate 8 with a visible adsorbent layer 9 and a carrier plate 10. The drawing shows a slight increase in the diameter of the sleeve 1 in that part of it where the edge 3 is in contact with the carrier plate 10. This causes a slight spreading of the adsorbent layer 9 and, as a result, a better fit of the edge 3 of the sleeve 1 to the carrier plate 10. This slight increase in the diameter of the lower part of the sleeve 1 is achieved under the influence of the force exerted by the arm of the pressure lever 24 and due to the shape of the lower part of the sleeve 1 given by the surface of the chamfer 4 and the outer surface of the wall of the sleeve 1. In an alternative example, the sleeve is made of acid-resistant steel and has an edge as shown in FIG. 1-6.

### EXAMPLE OF THE DEVICE 2

In a non-limiting embodiment example, an automatic device for extracting substances from an adsorbent layer is presented, in a four-channel version.

The device according to the invention in this embodiment is shown in FIG. 9 in the state before extraction and FIG. 10 during extraction with pressed sleeves 1. It comprises four sleeves 1, O-rings 29, a mounting beam 30, and a pressing mechanism 31. The body of the device 32 provides a rigid connection of the pressing mechanism 31 and the table 33 on which the chromatographic plate 8 is placed. The sleeves 1 are placed in the mounting beam 30, and their lower edge can freely adapt to the surface of the plate 10 carrying the chromatographic plate 8 thanks to the use of individual O-rings 29 for each sleeve 1. The O-rings 29 have a double function-they connect the sleeves 1 to the beam 30, and also hold them above the chromatographic plate 8. The groove 34 in the mounting beam 30 is designed to secure the O-rings 29, with their inner diameter being 30 mm. smaller than the diameter of the sleeve 1, which ensures its stable positioning inside the beam 30. The chamfer on the upper edge of the sleeve 1 facilitates its insertion into the O-ring 29.

The pressure mechanism 31, which may take the form of a pneumatic linear actuator or a screw mechanism driven by an electric motor, is responsible for the movement of the mounting beam 30 relative to the chromatographic plate 8. This mechanism is additionally equipped with a pair of strain gauge sensors 35, which precisely regulate the pressure force. After reaching the set force, the control system stops the movement of the actuators or motors, maintaining a constant level of force throughout the process. The use of a double pressure mechanism ensures uniform distribution of force on all sleeves 1, which is crucial for obtaining optimal extraction results. In the event that the mounting beam 30 and the chromatographic plate 8 are not perfectly parallel, the O-rings 29 allow for flexible adjustment of the lower edge of the sleeves 1 to the surface of the plate 10 supporting the chromatographic plate 8, which compensates for any deformations of the elements resulting from the action of the pressing force or tolerances of the components.

Alternatively, instead of O-rings, other flexible elements can be used that allow the beam to be connected to the sleeves, while maintaining their adjustment functionality.

The described solution can be used in devices with a larger or smaller number of channels, analogously to the described four-channel example. Thanks to the modular design, the device can be adapted to various research needs, ensuring high flexibility and efficiency in the process of extracting substances from the adsorbent layer.

### EXAMPLE OF THE DEVICE 3

The device according to the invention in this embodiment example is shown in the drawing, FIG. 11 in a state allowing easy replacement of sleeves—with the mounting beam turned upwards and in the drawing FIG. 12 during extraction with the sleeves pressed against the chromatographic plate.

In this variant, the chromatographic plate 8 is pressed against the static mounting beam 36, which is equipped with sleeves 1 and O-rings 37. The plate is placed on a movable table 38, which-similarly to the second variant—uses a double pressing mechanism 39, which can be in the form of a pneumatic actuator or a screw mechanism driven by an electric motor. The system is equipped with two tensometric sensors 40, which precisely control the pressing force, maintaining it at a constant level during the entire extraction process.

The role of the O-rings 37 is crucial here—they act as a connector between the sleeves 1 and the pressure beam 36, while allowing for free adjustment of the lower edge of the sleeve 1 to the surface of the plate 10 supporting the chromatographic plate 8. This solution compensates for any inaccuracies in the manufacture of the components and deformations resulting from the application of the pressure force. The O-rings 37 allow the sleeves 1 to move in the beam 36 in such a way that each of them can adjust to the unevenness of the plate 8 or the pressure beam 36, which guarantees correct adjustment and ensures optimal contact during the extraction process. The use of O-rings 37 with a smaller internal diameter than the diameter of the cooperating sleeve 1 ensures their secure retention inside the grooves 41 of the beam in FIG. 11 and FIG. 12. The chamfer 42 on the upper edge of the sleeve makes it easier to insert it into the O-ring 37. The chamfer on the upper edge can also be used for other sleeves according to the invention.

In the key innovation of this variant, the clamping beam 36 is connected to the rotation mechanisms 43 (connected to the body 44) which allow it to rotate through 180 degrees. Thanks to this design, rapid assembly and disassembly of the sleeves 1 is possible. Once the sleeves have been loaded by the arm, the beam 36 rotates towards the chromatographic plate 8 and the pressing process is then started.

In situations where the clamping beam 36 and the chromatographic plate 8 are not perfectly parallel, the O-rings 37 allow flexible adjustment of the sleeves 1, compensating for any manufacturing inaccuracies or deformations, which increases the reliability and efficiency of the device.

In this example, the sleeves can be replaced manually by the operator or by means of a manipulating arm, which can be an integral part of the extraction device or act as a separate device, cooperating with the extractor.

Thanks to the use of rotary mechanisms 43 and an automatic arm, the process of exchanging sleeves has been significantly simplified and automated, which increases the efficiency of the device and shortens the time needed to prepare for subsequent extraction operations. The use of O-rings and the elasticity of the sleeves ensure proper adjustment to the plate, even in the case of minor deformations or unevenness.

### APPLICATION EXAMPLE

An example of the use of the device is presented below for coccidiostats, i.e. substances preventing coccidiosis in farm animals, used as feed additives. The experiments were carried out for five selected coccidiostats: maduramicin, narasin, salinomycin, monensin, lasalocyu and nigericin as an internal standard. The stock solutions were prepared by weighing the appropriate amount of each substance and dissolving in methanol so that the concentration of each coccidiostat was 1000 μg/ml. In the case of solutions of substances in pure solvent, the solutions used to prepare the calibration curves were prepared from stock solutions so that the final concentration of coccidiostats in the sample was 0.1; 0.4; 0.9; 2.0; 4.0; 8.0; 12.0 mg/l, respectively. The concentration of the internal standard was 0.25 mg/ml. In the case of solutions of substances added to poultry feed, 2.5 g of feed was weighed into a 50 ml polypropylene centrifuge tube, and then working solutions prepared from stock solutions were added so that the final concentration of coccidiostats in the sample was 0.1; 0.4; 0.9; 2.0; 4.0; 8.0; 12.0 mg/kg, respectively, and the concentration of the internal standard was 0.25 mg/kg. The sample was then shaken. 10 ml of acetonitrile was added and the sample was shaken vigorously again. The obtained solutions of the tested coccidiostats, each with a volume of 5 μl, were applied to the adsorbent layer of a chromatographic plate with silica gel (HPTLC Silica gel 60 F254) using a semi-automatic pipette. The zones of the tested substances were extracted using a device according to the present description of the invention. To extract the substances from the place of application to the chromatographic plate, one portion of methanol with a volume of 50 μl was used, which was introduced into a microvessel formed by the carrier plate (8) of the chromatographic plate and the sleeve (1) pressed against the chromatographic plate with a force corresponding to the weight of the mass of 15 kg. During the extraction process, the upper opening of the microvessel was covered with a plug. After 5 min, the solutions were withdrawn from the microvessel using a 250 μl microsyringe fitted with a needle with a tip bevelled at an angle of 90° to the needle axis and transferred to 100 μl vials. These solutions were then filtered to remove solid particles from the adsorbent layer of the chromatography plate. The solutions (extracts) obtained in this way were analyzed using the LC-MS technique (HPLC 1290 Infinity liquid chromatograph with DAD UV-VIS detector, Agilent, USA; column: Zorbax Eclipse Plus C18, 4.6×100 mm; 3.5 μm, Agilent, USA: mobile phase: 94.9% methanol, 5% water and 0.1% formic acid (% by volume); triple quadrupole mass spectrometer: 6460 Agilent, USA), which resulted in obtaining dependencies of the ratio of the peak area of the tested substances to the peak area of the internal standard on the concentration of the substance in the methanol samples and in the samples with feed. The obtained dependencies are given below in the form of straight line equations and with the values of the coefficient of determination, R2. They were obtained for seven different concentrations of the tested substances in the range from 0.1 to 12 mg/dm3. For each concentration, three measurements were made of the ratio of the peak area of the substance to the peak area of the internal standard.

Results for solutions of coccidiostats dissolved in methanol:

| Tested coccidiostats | Linearity equation | R² |
|---|---|---|
| lasalicide | y = 0.0206x + 0.0209 | 0.946 |
| monensin | y = 0.7706 | 0.995 |
| salinomycin | y = 0.199x + 0.1288 | 0.980 |
| narasin | 0.4387x | 0.998 |
| maduramycin | y = 0.105x + 0.042 | 0.994 |

Results for samples of poultry feed supplemented
with coccidiostats mixed with methanol:

| Tested coccidiostats | Linearity equation | R² |
|---|---|---|
| lasalicide | y = 0.0189x + 0.0155 | 0.954 |
| monensin | y = 0.7795x + 0.1097 | 0.999 |
| salinomycin | y = 0.2185x + 0.135 | 0.989 |
| narasin | y = 0.46 + 0.1225 | 0.999 |
| maduramycin | y = 0.105x + 0.042 | 0.994 |

Based on the obtained results, it can be concluded that the ratio of the peak area of the tested substances to the peak area of the internal standard, depending on the concentration of the tested substances for the extract solutions obtained using the method and device according to the proposed invention, shows a very good rectilinear relationship.

1-29. (canceled)

30. A method of extracting a substance from an adsorbent layer of a chromatographic plate, the method comprising:
pressing a sleeve against a carrier plate of the chromatographic plate at a location on the adsorbent layer to form a microvessel, wherein the sleeve is pressed perpendicular to the carrier plate such that a bottom of the microvessel is defined by the carrier plate and a wall of the microvessel is defined by an inner wall of the sleeve;
introducing an extracting liquid into the microvessel through an upper opening of the sleeve, wherein a volume of the extracting liquid is between 20 μL and 500 μL;
maintaining the extracting liquid in contact with the adsorbent layer for a time period in a range of 1 minute to 10 minutes; and
withdrawing an extract from the microvessel, wherein the extract comprises the extracting liquid with extracted substances.

31. The method of claim 30, wherein the extract is withdrawn from the microvessel using a syringe or pipette.

32. The method of claim 30, further comprising directing the extract to instrumental analysis.

33. The method of claim 30, further comprising separating solid particles of the adsorbent layer from the extract.

34. The method of claim 33, wherein the solid particles are separated by filtration or centrifugation.

35. The method of claim 30, wherein the microvessel has an internal opening with a circular cross-section having a diameter of 2 mm to 10 mm.

36. The method of claim 30, further comprising:
withdrawing a portion of the extracting liquid from the microvessel;
reintroducing the withdrawn portion into the microvessel; and
repeating the withdrawing and reintroducing steps 2 to 10 times.

37. The method of claim 30, wherein the extracting liquid is mixed in the microvessel by shaking or ultrasound.

38. The method of claim 30, wherein the upper opening of the sleeve is closed with a plug having an opening during the maintaining step.

39. The method of claim 30, wherein the sleeve has a height of up to 50 mm.

40. A device for extracting substances from a chromatographic plate, the device comprising:
a body;
a table for placing the chromatographic plate;
at least one sleeve having a lower edge configured to contact an adsorbent layer of the chromatographic plate;
a holder connected to the body and configured to secure the at least one sleeve;
a pressing mechanism connected to the body and configured to press the at least one sleeve perpendicular to the chromatographic plate and to displace the at least one sleeve from the chromatographic plate; and
an elastic element configured to adjust an edge of the at least one sleeve to the chromatographic plate.

41. The device of claim 40, wherein the at least one sleeve is replaceable and is made of a chemically inert material.

42. The device of claim 40, wherein the at least one sleeve comprises a lower edge that is sharply terminated along an entire circumference, wherein the lower edge is formed by a connection of an outer surface of the sleeve and a chamfered inner surface of the sleeve.

43. The device of claim 42, wherein an angle between surfaces forming the sharply terminated lower edge is in a range of 15° to 70°.

44. The device of claim 40, wherein the at least one sleeve has at least one opening in a wall of the sleeve near an upper end of the sleeve, wherein the at least one opening has a diameter in a range of 0.3 mm to 1.5 mm.

45. The device of claim 40, wherein an internal cross-section of the at least one sleeve has a circular shape with a diameter of 2 mm to 10 mm, or an oval shape with a shorter axis of 2 mm to 6 mm and a longer axis of 3 mm to 10 mm.

46. The device of claim 40, wherein the at least one sleeve has a length of 5 mm to 50 mm.

47. The device of claim 40, wherein the holder is connected to the pressing mechanism via the elastic element.

48. The device of claim 40, wherein the pressing mechanism comprises a turnbuckle, a lever, an upper pressing plate, and a lower pressing plate, wherein the lower pressing plate is connected to the holder via the elastic element.

49. The device of claim 40, further comprising strain gauge sensors connecting the pressing mechanism to the holder, wherein the strain gauge sensors are configured to measure pressing force applied to the at least one sleeve.
